(19) United States
(12) Patent Application Publication
(10) Pub. No.: US 2017/0031633 A1
(43) Pub. Date: Feb. 2, 2017

(54) METHOD OF OPERATING OBJECT-ORIENTED DATA STORAGE DEVICE AND METHOD OF OPERATING SYSTEM INCLUDING THE SAME

(71) Applicant: SAMSUNG ELECTRONICS CO., LTD., Suwon-si (KR)

(72) Inventor: Yong In LEE, Yongin-si (KR)

(73) Assignee: SAMSUNG ELECTRONICS CO., LTD., Suwon-si (KR)

(21) Appl. No.: 15/204,369

(22) Filed: Jul. 7, 2016

(30) Foreign Application Priority Data
Jul. 27, 2015 (KR) 10-2015-0105583

(51) Int. Cl. G06F 3/06

(52) U.S. Cl. CPC G06F 3/0659; G06F 3/0604; G06F 3/0673; G06F 3/067

(57) ABSTRACT

A method of operating a data storage device, which is connected with a host and includes a memory device and a controller, is provided. The method includes receiving, by the controller, a first instance in object-oriented programming language, which corresponds to a write command output from the host; transforming, by the controller, the first instance into first object data; and programming, by the controller, the first object data to the memory device.

### CROSS-REFERENCE TO RELATED APPLICATION

This application claims priority from Korean Patent Application No. 10-2015-0105583 filed on Jul. 27, 2015, in the Korean Intellectual Property Office, the disclosure of which is hereby incorporated by reference in its entirety.

### BACKGROUND

Devices and methods consistent with exemplary embodiments relate to a data storage device, more particularly, to a data storage device for accessing an instance in an object-oriented programming language and translating the instance into object data and vice versa, and to a data processing system including the same.

For using data stored in a memory device, an application program transforms the data into a format readable by the application program while reading the data from the memory device. Such a reprocessing operation may be performed in the main memory of a computer system. When a speed of a central processing unit (CPU) in a host executing the application program is fast enough to accommodate the data bandwidth processed by the memory device, the reprocessing of the application program for the transforming (i.e., the reprocessing by the CPU) is not influenced by the operating speed of the memory device.

However, when the inputted data bandwidth is larger than the processing speed of a CPU in a host can accommodates, the reprocessing speed of the CPU become a bottleneck in communicating between the CPU and the memory device resulting in the performance degradation of the system.

### SUMMARY

One or more exemplary embodiments provide a method of storing an instance in an object-oriented programming language in a memory device embedded in a data storage device or performing translating the instance into object data in the data storage device and vice versa in order to reduce or disperse a calculation load occurring during a process of writing data to the memory device and reading data from the memory device in a computer system, data storage device, and a data processing system including the data storage device.

According to an aspect of an exemplary embodiment, there is provided a method of operating a data storage device which is connected with a host and includes a memory device and a controller. The method may include receiving, by the controller, a first instance in object-oriented programming language in response to write command from the host, transforming, by the controller, the first instance into first object data, and programming, by the controller, the first object data into the memory device.

The method may further include reading the first object data from the memory device in response to a read command from the host, transforming the first object data into the first instance, and transmitting the first instance to the host.

The data storage device may be a solid state drive (SSD) and the memory device may be identified by one of channels and one of ways.

The controller may include two central processing units (CPUs). The first central processing unit (CPU) may be related to communication with the host and the second CPU may be related to control of the memory device such as transforming the first instance into the first object data and transforming the first object data into the first instance. The second CPU may include an application programming interface (API) to perform the transforming. The first CPU and the second CPU may share a semiconductor substrate with each other or may be formed in different chips respectively.

The data storage device may further include dynamic random access memory (DRAM) connected to the controller. The controller and the DRAM may be packaged in a single package. Additionally, the controller, the DRAM, and the memory device may be packaged in a single package. The object-oriented programming language may be Java programming language.

According to an aspect of another exemplary embodiment, there is a method of operating a data processing system which includes a host and a data storage device. The method includes receiving a first instance in object-oriented programming language in response to a write command from the host by a controller embedded in the data storage device, transforming the first instance into first object data, and programming, the first object data to a memory device embedded in the data storage device.

The method may further include reading, by the controller, the first object data from the memory device in response to a read command from the host; transforming the first object data into the first instance; and transmitting the first instance to the host. The data storage device may be a direct attached storage (DAS), a data storage for a storage area network (SAN), or a network attached storage (NAS).

According to an aspect of another exemplary embodiment, there is provided a method of operating a data processing system which includes a host and a data storage device. The method includes transmitting, by the host, an instance in object-oriented programming language to the data storage device during a write operation, and programming, by the data storage device, the instance to a second memory device embedded in the data storage device during the write operation.

The method may further include reading, by the data storage device, the instance from the second memory device in response to a read command from the host during a read operation; and transmitting, by the data storage device, the instance to the host.

The method may further include, before the write operation, transmitting, by the host, a read command to the data storage device; transmitting, by the data storage device, object data that has been stored in the second memory device to the host in response to the read command; and transforming, by the host, the object data into the instance and storing the instance in the first memory device.

### BRIEF DESCRIPTION OF THE DRAWINGS

The above and/or other aspects of exemplary embodiments will be more clearly understood from the following detailed description taken in conjunction with the accompanying drawings in which:

FIG. 1 is a block diagram of a data processing system according to an exemplary embodiment;

FIG. 2 is a perspective view of a data storage device illustrated in FIG. 1;

FIG. 3 is a schematic block diagram for explaining the operation of the data processing system illustrated in FIG. 1 according to an exemplary embodiment;

FIG. 4 is a detailed block diagram for explaining the operation of the data processing system illustrated in FIG. 3;

FIG. 5 is a diagram of an instance in object-oriented programming and a Java object;

FIG. 6 is a schematic block diagram for explaining the operation of the data processing system illustrated in FIG. 1 according to an exemplary embodiment;

FIG. 7 is a detailed block diagram for explaining the operation of the data processing system illustrated in FIG. 6;

FIG. 8 is a block diagram of a data processing system according to an exemplary embodiment;

FIG. 9 is a block diagram of a data processing system according to an exemplary embodiment; and

FIG. 10 is a block diagram of a data processing system according to an exemplary embodiment.

### DETAILED DESCRIPTION OF EXEMPLARY EMBODIMENTS

Exemplary embodiments now will be described more fully hereinafter. This inventive concept may be embodied in many different forms and should not be construed as limited to the embodiments set forth herein. Rather, these embodiments are provided so that this disclosure will be thorough and complete, and will fully convey the for explaining the scope of the inventive concept to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

In object-oriented programming (OOP), an object is a software bundle of related state and behavior. A class is a blueprint or prototype from which objects are created. An instance is a single and unique unit of a class. The creation of an instance is called instantiation. An object created using a class may be an instance of the class. An instance may refer to an object in memory (or a memory device). For example, an instance of an object may refer to an instance.

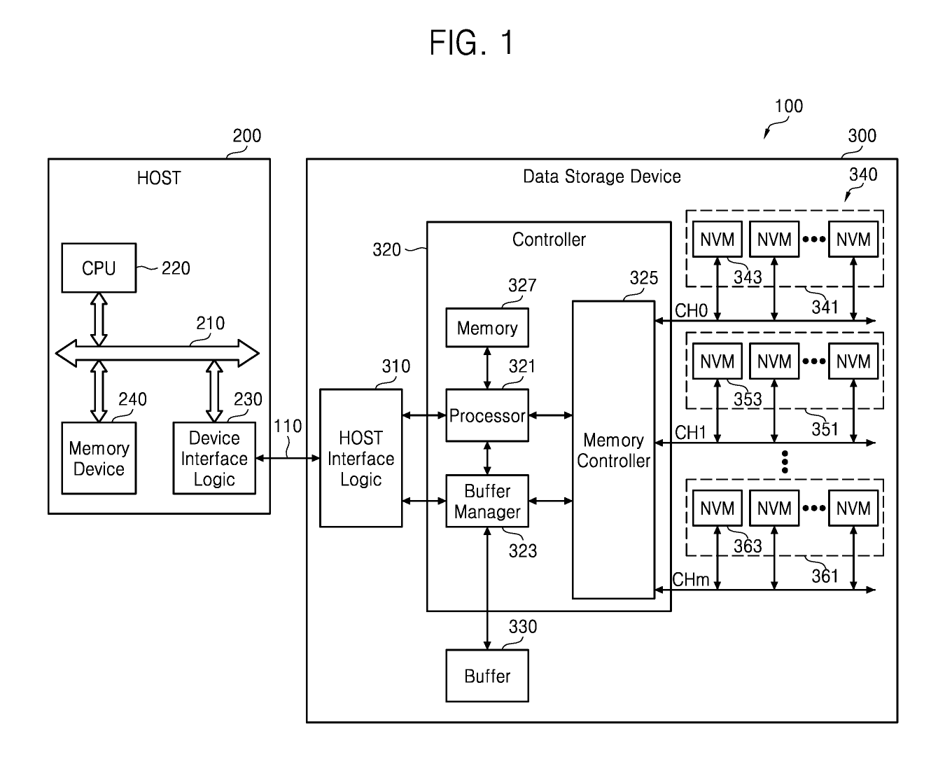

FIG. 1 is a block diagram of a data processing system 100 according to an exemplary embodiment. Referring to FIG. 1, the data processing system 100 may include a host 200 and a data storage device 300 configured to communicate a command and/or data with the host 200 via an interface 110. In an example embodiment, the host 200 and the data storage device 300 may transmit or receive an instance without reprocessing it, and a controller 320 of the data storage device 300 may transform an instance into object data and vice versa.

In an example embodiment, the data processing system 100 may be implemented as a personal computer (PC), a workstation, a data center, an internet data center (IDC), a direct attached storage (DAS), a storage area network (SAN), a network attached storage (NAS), or a mobile computing device, but the inventive concept is not limited to the example embodiment. A mobile computing device may be a laptop computer, a cellular phone, a smartphone, a tablet PC, a personal digital assistant (PDA), an enterprise digital assistant (EDA), a digital still camera, a digital video camera, a portable multimedia player (PMP), a personal navigation device or portable navigation device (PND), a handheld game console, a mobile internet device (MID), a wearable computer, an internet of things (IoT) device, an internet of everything (IoE) device, a drone, or an e-book.

According to an example embodiment, the interface 110 may be a serial advanced technology attachment (SATA) interface, a SATA express (SATAe) interface, a SAS (serial attached small computer system interface (SCSI)), a peripheral component interconnect express (PCIe) interface, a non-volatile memory express (NVMe) interface, an advanced host controller interface (AHCI), or a multimedia card (MMC) interface but is not restricted thereto. The interface 110 may transmit electrical or optical signals.

The host 200 may control a data processing operation (e.g., a write or read operation) of the data storage device 300 via the interface 110. The host 200 may refer to a host controller.

A central processing unit (CPU) 220 and a first interface 230 may transmit or receive a command and/or data with each other via bus architecture (or a bus) 210. The data may include an instance or object data. Although the host 200 includes the bus architecture 210, the CPU 220, the first interface 230, and a memory device 240 in the exemplary embodiments illustrated in FIG. 1, the inventive concept is not limited to the host 200 including the elements 210, 220, 230, and 240 illustrated in FIG. 1.

The host 200 may be implemented as an integrated circuit (IC), a motherboard, a system on chip (SoC), an application processor (AP), a mobile AP, a web server, a data server, or a database server, but the inventive concept is not limited to these examples. For example, the bus architecture 210 may be implemented as an advanced microcontroller bus architecture (AMBA), an advanced high-performance bus (AHB), an advanced peripheral bus (APB), an advanced extensible interface (AXI), an advanced system bus (ASB), AXI coherency extensions (ACE), or a combination thereof, but the inventive concept is not limited to these examples.

The CPU 220 may generate a write request for controlling a write operation of the data storage device 300 or a read request for controlling a read operation of the data storage device 300. The write request may include a write address and the read request may include a read address. For example, the CPU 220 may include one or more cores. The request may refer to a command.

For example, the CPU 220 may run a virtual machine (VM). In computing, a VM is emulation of a particular computer system. VMs operate based on computer architecture and functions of a real or hypothetical computer and may be implemented in hardware, software, or a combination thereof.

The first interface 230 may change the format of a command and/or data to be transmitted to the data storage device 300 and may transmit the command and/or data in a changed format to the data storage device 300 through the interface 110. The first interface 230 may be referred to as a device interface logic (or a device interface logic circuit). The first interface 230 may also change the format of a response and/or data received from the data storage device 300 and may transmit the response and/or data in a changed format to the CPU 220 through the bus architecture 210. The first interface 230 may include a transceiver which transmits and receives a command and/or data. The structure and operations of the first interface 230 may be configured to be compatible with those of the interface 110.

The memory device 240 may store data that has been processed by the CPU 220 or data to be processed by the CPU 220. For example, the memory device 240 may store an instance created by the CPU 220. The memory device 240 may be formed of volatile memory and/or non-volatile memory. For example, the volatile memory may be random access memory (RAM), dynamic RAM (DRAM), or a static RAM (SRAM) but is not limited thereto. For example, the memory device 240 may be a main memory device. The non-volatile memory may be NAND flash memory. Although the memory device 240 is disposed within the host 200 in the exemplary embodiments illustrated in FIG. 1, the memory device 240 may be provided outside the host 200 in other exemplary embodiments.

The data storage device 300 may include a second interface 310, a controller 320, a buffer 330, and a memory cluster 340. The memory cluster 340 may be a group of memory devices NVM.

The data storage device 300 may be a flash-based storage but is not limited thereto. For example, the data storage device 300 may be implemented as a solid-state drive or solid-state disk (SSD), an embedded SSD (eSSD), a universal flash storage (UFS), an MMC, an embedded MMC (eMMC), or managed NAND, but the inventive concept is not limited to these examples. The flash-based storage may be implemented as a NAND-type flash memory device or a NOR-type flash memory device. Alternatively, the data storage device 300 may be implemented as a hard disk drive (HDD), a phase-change random access memory (PRAM) device, a magnetoresistive RAM (MRAM) device, a spin-transfer torque MRAM (STT-MRAM) device, a ferroelectric RAM (FRAM) device, or a resistive RAM (RRAM) device, but the inventive concept is not limited to these examples.

The second interface 310 may transmit a response and/or data in a changed format to the host 200 through the interface 110. The second interface 310 may also receive a command and/or data from the host 200. The second interface 310 may include a transceiver which transmits and receives a signal and/or data. The second interface 310 may be referred to as a host interface logic (or a host interface logic circuit).

The structure and operations of the second interface 310 may be configured to be compatible with those of the interface 110. For example, the second interface 310 may be SATA interface, SATAe interface, SAS, PCIe interface, NVMe interface, AHCI, MMC interface, NAND-type flash memory interface, or NOR-type flash memory interface but is not limited thereto.

The controller 320 may control transmission or processing of a command and/or data transferred among the second interface 310, the buffer 330, and the memory cluster 340. According to an example embodiment, the controller 320 may be implemented in an IC or SoC, but the inventive concept is not limited to these examples. The controller 320 may write, as it is, an instance received from the host 200 to the memory cluster 340 and may transmit, as it is, an instance read from the memory cluster 340 to the host 200. The controller 320 may also transform an instance into object data or transform object data into an instance.

The controller 320 may include a processor 321, a buffer manager 323, and a third interface 325. The processor 321, the buffer manager 323, and the third interface 325 may communicate with one another via bus architecture. The bus architecture may be implemented as AMBA, AHB, APB, AXI, ASB, ACE, or a combination thereof, but the inventive concept is not limited to these examples.

The controller 320 may also include an internal memory 327. The internal memory 327 may store data for the operations of the controller 320 or data generated from a data processing operation (e.g. a write or read operation) performed by the controller 320. For example, the internal memory 327 may store a flash translation layer (FTL) that can be executed by the processor 321. For example, when the data storage device 300 is booted, the FTL may be loaded from the memory cluster 340 to the internal memory 327 and may be executed by the processor 321. According to an example embodiment, the internal memory 327 may be implemented as RAM, DRAM, SRAM, buffer, buffer memory, cache, or tightly couple memory (TCM), but the type of the internal memory 327 is not limited to these examples.

The processor 321 may control each of the elements 310, 323, 325, and 327. The processor 321 may include one or more cores. The cores may share one semiconductor substrate with one another or may be formed in different semiconductor chips respectively. Although one processor 321 is illustrated in FIG. 1, the controller 320 may include a first processor and a second processor.

The first processor may be a first CPU which may transmit or receive data with the host 200 via the second interface 310. The second processor may be a second CPU which may transmit or receive data with the memory cluster 340 via the third interface 325. For example, the first CPU and the second CPU may form multi-CPU. The first CPU may control the second CPU, but the inventive concept is not limited to the example embodiments. The processor 321 may collectively denote the processor 321, the first processor, and/or the second processor.

The buffer manager 323 may write data to or read data from the buffer 330 according to the control of the processor 321. The second interface 310 may transmit or receive data with the buffer manager 323. The buffer manager 323 may be referred to as a buffer controller which controls write and read operations on the buffer 330.

The third interface 325 may control a data processing operation (e.g., a write operation or a read operation) of each of non-volatile memory devices NVM connected to each of channels CH0 through CHm (where “m” is an integer of two or greater) according to the control of the processor 321 or the buffer manager 323. The third interface 325 may be a memory controller. When each non-volatile memory device NVM is a flash memory device, the third interface 325 may be a flash memory controller.

In an example embodiment, the third interface 325 may be SATA interface, SATAe interface, SAS, PCIe interface, NVMe interface, AHCI, MMC interface, NAND-type flash memory interface, or NOR-type flash memory interface but is not limited thereto. The third interface 325 may include an error correction code (ECC) engine. The ECC engine may correct an error in data to be stored in or output from the memory cluster 340. The ECC engine may be implemented in any place within the controller 320.

The buffer 330 may write data to its first data storage region or read data from its second data storage region according to the control of the buffer manager 323. The buffer 330 may be implemented as a buffer memory, a RAM, an SRAM, or a DRAM, but the inventive concept is not limited to these examples.

The buffer 330 may include a first region which stores a mapping table for logical address-to-physical address translation with respect to memory cluster 340 and a second region which functions as a cache, but the inventive concept is not limited to the example embodiment. For example, the FTL executed by the processor 321 may perform logical address-to-physical address translation using the mapping table stored in the first region.

When the controller 320 and the buffer 330 are formed in different semiconductor chips, respectively; the controller 320 and the buffer 330 may be implemented in a single package using package-on-package (PoP), multi-chip package (MCP), or system-in package (SiP), but the inventive concept is not limited to these examples. A first chip including the buffer 330 may be stacked on or above a second chip including the controller 320 using stack balls, but the inventive concept is not limited to the example embodiment. The controller 320, the buffer 330, and the memory cluster 340 may be formed in a single package (e.g., an embedded PoP (ePoP)).

The memory cluster 340 may include a plurality of clusters 341, 351, and 361. Non-volatile memory devices 343 included in the first cluster 341 may be connected to the first channel CH0, non-volatile memory devices 353 included in the second cluster 351 may be connected to the second channel CH1, and non-volatile memory devices 363 included in the m-th cluster 361 may be connected to the m-th channel CHm.

Here, the term “channel” may refer to an independent data path existing between the controller 320 or the third interface 325 and a cluster. The data path may include transmission lines that transmit data and/or control signals. The term “way” may refer to a group of one or more non-volatile memory devices NVM sharing one channel. For instance, each of the clusters 341, 351, and 361 may be a way.

When a non-volatile memory device included in the memory cluster 340 is a NAND flash memory device, the NAND flash memory device may include a memory cell array and a control circuit which controls the operation of the memory cell array. The memory cell array may include a three-dimensional memory cell array. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In an exemplary embodiment, the 3D memory array includes vertical NAND strings that are vertically oriented such that at least one memory cell is located over another memory cell. The at least one memory cell may comprise a charge trap layer. The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587 and 8,559,235; and U.S. Patent Application Publication No. 2011/0233648.

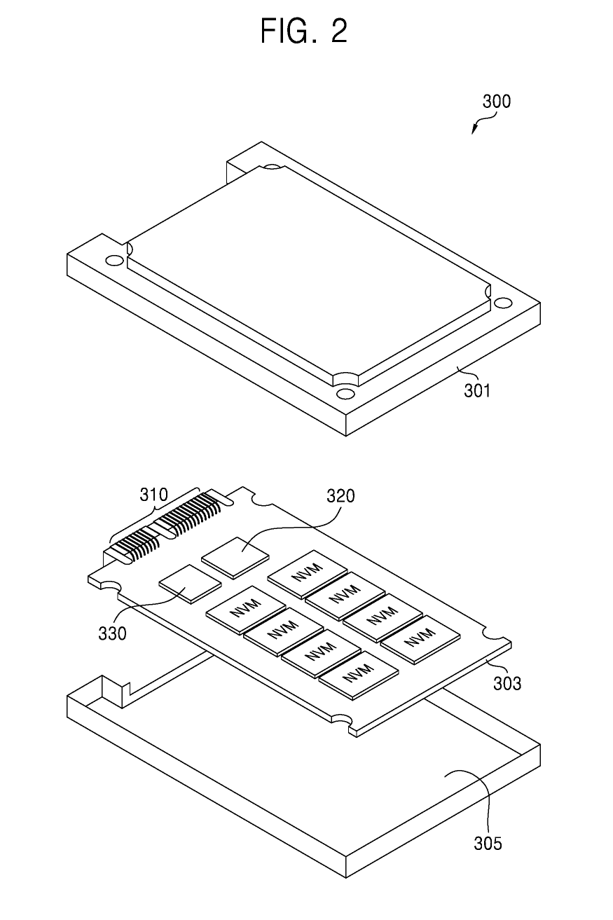

FIG. 2 is a perspective view of a data storage device 300 illustrated in FIG. 1. Referring to FIGS. 1 and 2, the data storage device 300 may be implemented as an SSD. The SSD 300 may include a top cover 301, an interface connector (i.e., a second interface) 310, a controller (e.g., an SSD controller) 320, a buffer (e.g., a DRAM device) 330, a non-volatile memory devices NVM, and a bottom cover 305. The controller 320 may refer to a controller chip. The buffer 330 may refer to a cache chip. The non-volatile memory devices NVM may be placed on one side or both sides of a logic board 303. The logic board 303 may be a printed circuit board (PCB).

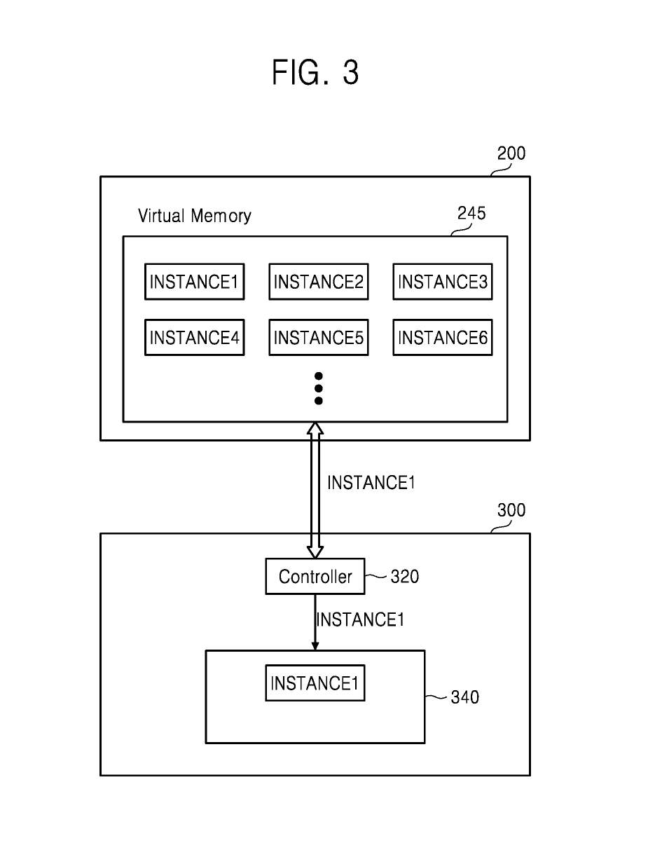

FIG. 3 is a schematic block diagram for explaining the operation of the data processing system 100 illustrated in FIG. 1 according to an exemplary embodiment. Referring to FIGS. 1 through 3, the host 200 may transmit or receive at least one (e.g., INSTANCE1) of instances INSTANCE1 through INSTANCE6 with the data storage device 300 as it is. Each of the instances INSTANCE1 through INSTANCE6 may be instances that are used in object-oriented programming language.

According to the control of the controller 320, the data storage device 300 may receive an instance (e.g., INSTANCE1) from the host 200 and write the instance INSTANCE1 as it is to at least one of the non-volatile memory devices NVM included in the memory cluster 340 or may read an instance (e.g., INSTANCE1) from one of the non-volatile memory devices NVM and transmit the instance INSTANCE1 as it is to the host 200. In other words, the controller 320 does not perform reprocessing of an instance (e.g., INSTANCE1). As described above, the reprocessing may refer to transforming an instance into object data and/or transforming object data into an instance.

For example, the instances INSTANCE1 through INSTANCE6 may be created by the CPU 220 (or VM or application programming interface (API) run by the CPU 220). The CPU 220 may store each of the instances INSTANCE1 through INSTANCE6 in a virtual memory 245. Here, the virtual memory 245 is a memory management technique implemented in hardware and software. The virtual memory 245 may map memory addresses to physical addresses in computer memory using a program called virtual addresses.

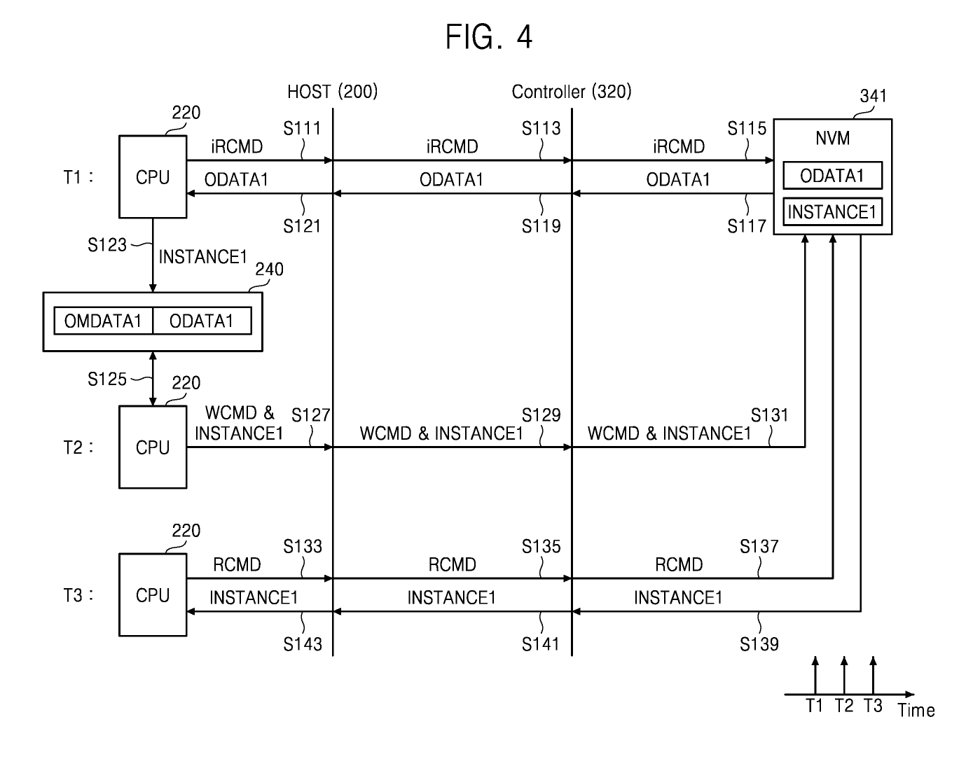

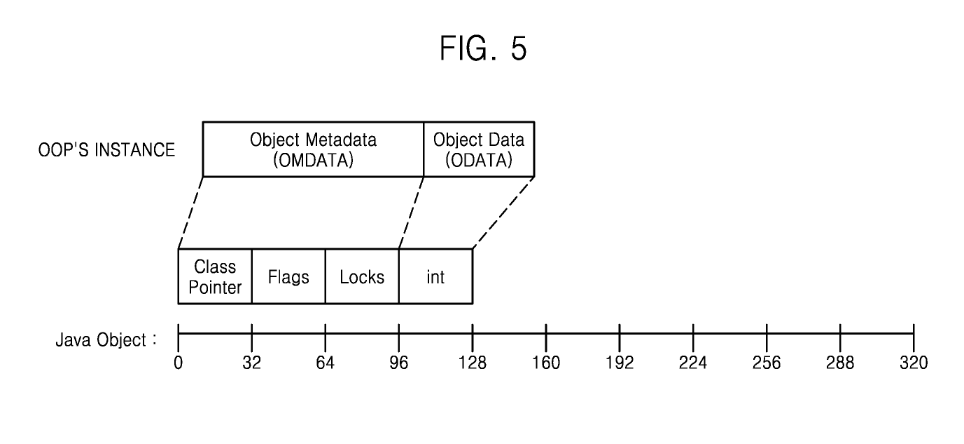

FIG. 4 is a detailed block diagram for explaining the operation of the data processing system 100 illustrated in FIG. 3. FIG. 5 is a diagram of an instance in object-oriented programming and a Java object. Referring to FIGS. 1 through 5, an instance OOP'S INSTANCE may include an object metadata OMDATA and object data ODATA in object-oriented programming language. The object metadata OMDATA may be data used to describe an object (or an instance). As shown in FIG. 5, when an instance is an instance of a Java object, the object metadata OMDATA may include a class point, flags, and locks.

The class pointer is a pointer to class information, which describes an a type of object. When the object is a java.lang.Integer object, the class pointer is a pointer to a java.lang.Integer class.

The flags are a collection of flags that describe the state of the object, including the hash code for the object if it has one, and the shape of the object (that is, whether or not the object is an array). The locks are synchronization information for the object (that is, whether the object is currently synchronized).

In FIG. 5, the object data ODATA includes “int” that denotes an integer value which is real data. For instance, in the layout of the java.lang.Integer object for 32-bit Java, 128 bits of data are used to store an integer value (i.e., 32-bit data).

Referring to FIG. 4, at a first time point T1, the CPU 220 of the host 200 that can run a VM (e.g., a Java VM (JVM)) may generate a read command iRCMD in operation S111. The controller 320 may receive the read command iRCMD from the host 200 in operation S113 and may read data (e.g., first object data ODATA1) related to the read command iRCMD from at least one of the non-volatile memory devices NVM included in the first cluster 341 in operations S115 and S117. The controller 320 may transmit the first object data ODATA1 to the host 200 in operation S119. The CPU 220 may receive the first object data ODATA1 in operation S121 and may transform the first object data ODATA1 into the first instance INSTANCE1 and store the first instance INSTANCE1 in the memory device 240 of the host 200 in operation S123. The first instance INSTANCE1 may include the first object data ODATA1 and first object metadata OMDATA1 that describes the first object data ODATA1. For example, the first instance INSTANCE1 may be stored in the virtual memory 245, as shown in FIG. 3.

For example, the first object data ODATA1 may be data that cannot be directly recognized by the object-oriented programming language and the first instance INSTANCE1 may be data that can be directly recognized by the object-oriented programming language. The object-oriented programming language may include Python, C++, Objective-C, Smalltalk, Delphi, Java, Swift, C#, Perl, and Ruby and PHP, but the inventive concept is not limited to these examples.

At a second time point T2, the CPU 220 of the host 200 may generate a write command WCMD and read write data (i.e., the first instance INSTANCE1) related to the write command WCMD from the memory device 240 in operation S125 and may transmit the write command WCMD and the first instance INSTANCE1 to the controller 320 of the data storage device 300 in operations S127 and S129. The controller 320 may write (or program) the first instance INSTANCE1 as it is to a memory region in at least one non-volatile memory device NVM included in the first cluster 341, which corresponds to the write command WCMD, in operation S131.

Although the JVM is exemplified as the VM in the exemplary embodiment illustrated in FIG. 4, the inventive concept is not limited to the JVM. In other words, the inventive concept may be directly applied to the host 200 using object-oriented programming or object-oriented programming language or the data storage device 300 including the host 200. In addition, the first object data ODATA1 and the first instance INSTANCE1 are stored in at least one non-volatile memory device NVM of the first cluster 341 in the exemplary embodiments illustrated in FIG. 4, but the first object data ODATA1 and the first instance INSTANCE1 may be stored in different clusters, respectively.

At a third time point T3, the CPU 220 of the host 200 may generate a read command RCMD for reading the first instance INSTANCE1 as it is in operation S133 and may send the read command RCMD to the controller 320 in operation S135. The controller 320 may read the first instance INSTANCE1 from the non-volatile memory device NVM of the first cluster 341 based on the read command RCMD (i.e., based on an address included in the read command RCMD) in operations S137 and S139 and may transmit the first instance INSTANCE1 as it is to the host 200 in operation S141. The first instance INSTANCE1 may be transmitted to the CPU 220 via the elements 230 and 210 in operation S143. Although an instance is exemplified in the exemplary embodiments, the inventive concept may also be applied to data defined as an object.

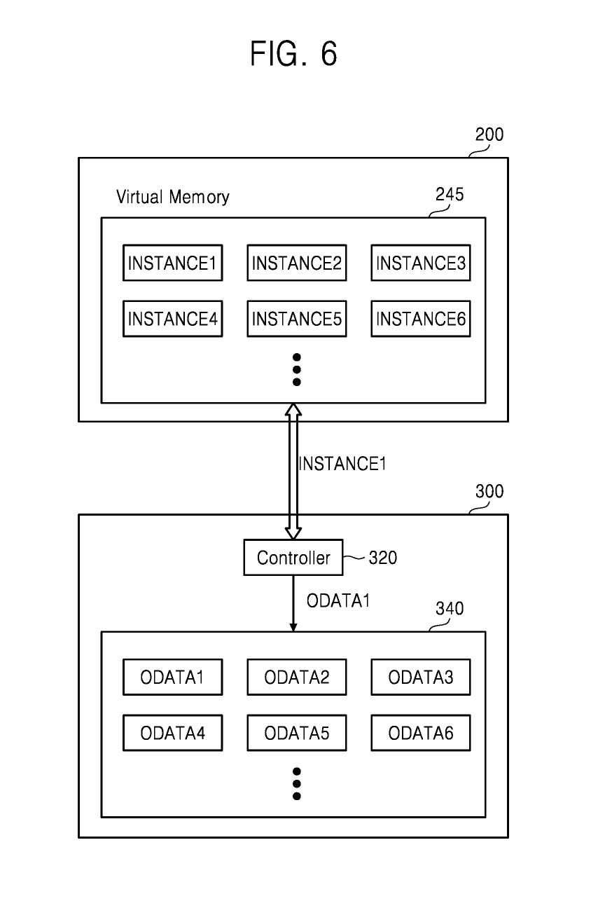

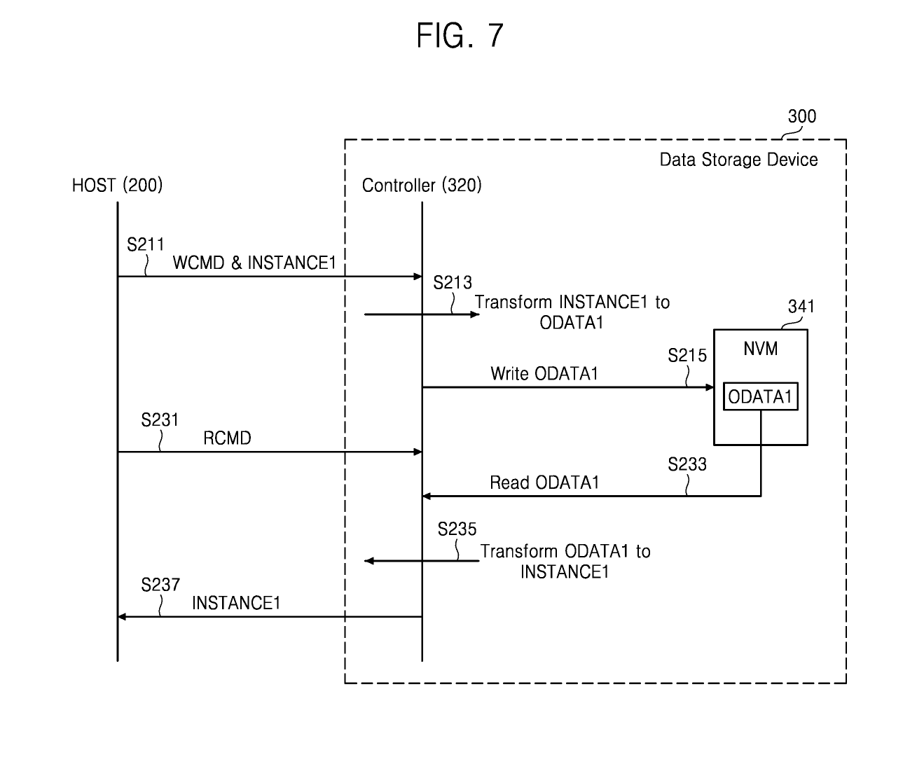

FIG. 6 is a schematic block diagram for explaining the operation of the data processing system 100 illustrated in FIG. 1 according to an exemplary embodiment. FIG. 7 is a detailed block diagram for explaining the operation of the data processing system 100 illustrated in FIG. 6. Conversion between an instance and object data performed by the data storage device 300 will be described in detail with reference to FIGS. 1, 2, 6, and 7 below.

During a write operation, the controller 320 may receive the write command WCMD and the first instance INSTANCE1 in object-oriented programming language from the host 200 in operation S211. The controller 320 may transform the first instance INSTANCE1 into the first object data ODATA1 in operation S213. The controller 320 may program the first object data ODATA1 to at least one non-volatile memory device NVM included in the first cluster 341 in operation S215.

During a read operation, the controller 320 may receive the read command RCMD output from the host 200 in operation S231 and may read the first object data ODATA1 from at least one non-volatile memory device NVM included in the first cluster 341 in response to the read command RCMD in operation S233. The controller 320 may transform the first object data ODATA1 into the first instance INSTANCE1 in operation S235. The controller 320 may transmit the first instance INSTANCE1 to the host 200 in operation S237.

When the controller 320 includes a first CPU related to the communication with the host 200 and a second CPU related to the control of at least one non-volatile memory device NVM included in the first cluster 341, operation S213 of transforming the first instance INSTANCE1 into the first object data ODATA1 and operation S235 of transforming the first object data ODATA1 into the first instance INSTANCE1 may be performed by an API run in the second CPU.

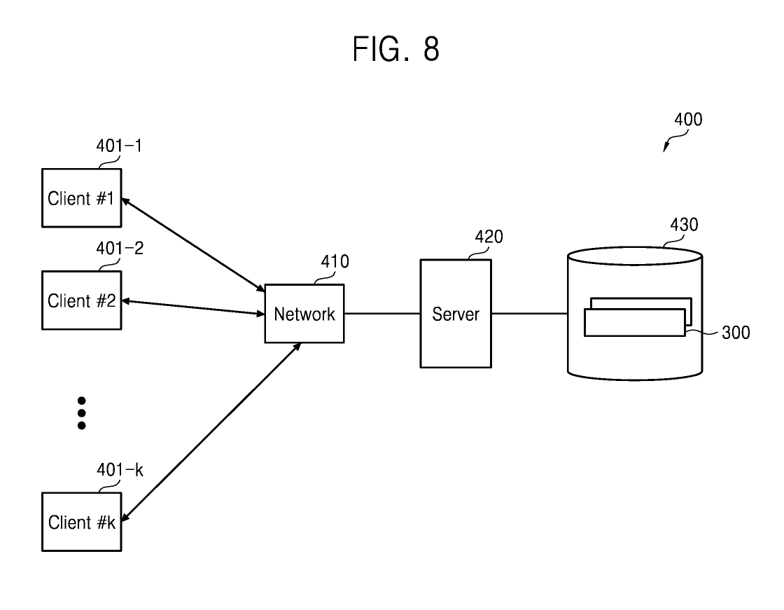

FIG. 8 is a block diagram of a data processing system 400 according to an exemplary embodiment. Referring to FIGS. 1 through 8, the data processing system 400 may include a plurality of client computers 401-1 through 401-k (where “k” is a natural number of at least 3), a network 410, a server 420, and a storage 430. Each of the client computers 401-1 through 401-k may be implemented as a PC or a mobile device. The storage 430 may include at least one data storage device 300.

The data processing system 400 may be a DAS system and the at least one data storage device 300 may be a DAS. The client computers 401-1 through 401-k may be connected to the server 420 via the network 410. The server 420 may control a data write operation and a data read operation of the storage 430. The server 420 may be directly connected with the storage 430.

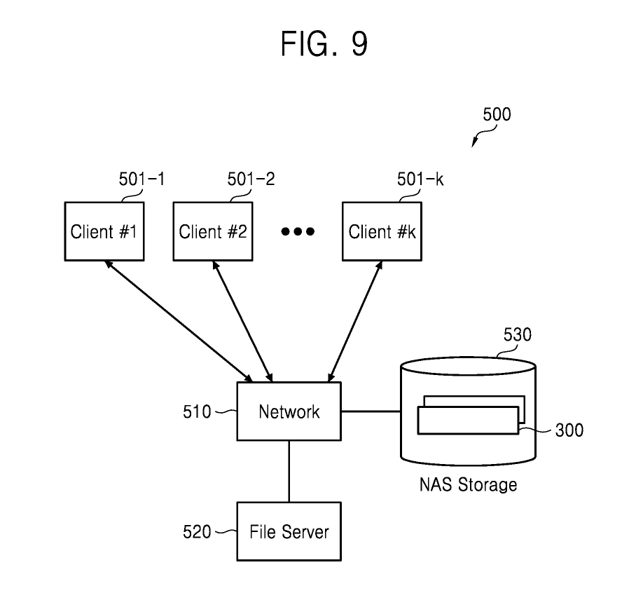

FIG. 9 is a block diagram of a data processing system 500 according to an exemplary embodiment. Referring to FIGS. 1 through 7 and FIG. 9, the data processing system 500 may include a plurality of client computers 501-1 through 501-k, a network 510, a file server 520, and a storage 530. Each of the client computers 501-1 through 501-k may be implemented as a PC or a mobile device. The storage 530 may include at least one data storage device 300.

The data processing system 500 may be a NAS system and the at least one data storage device 300 may be a NAS. The client computers 501-1 through 501-k may access the storage 530 via the file server 520 connected to the network 510.

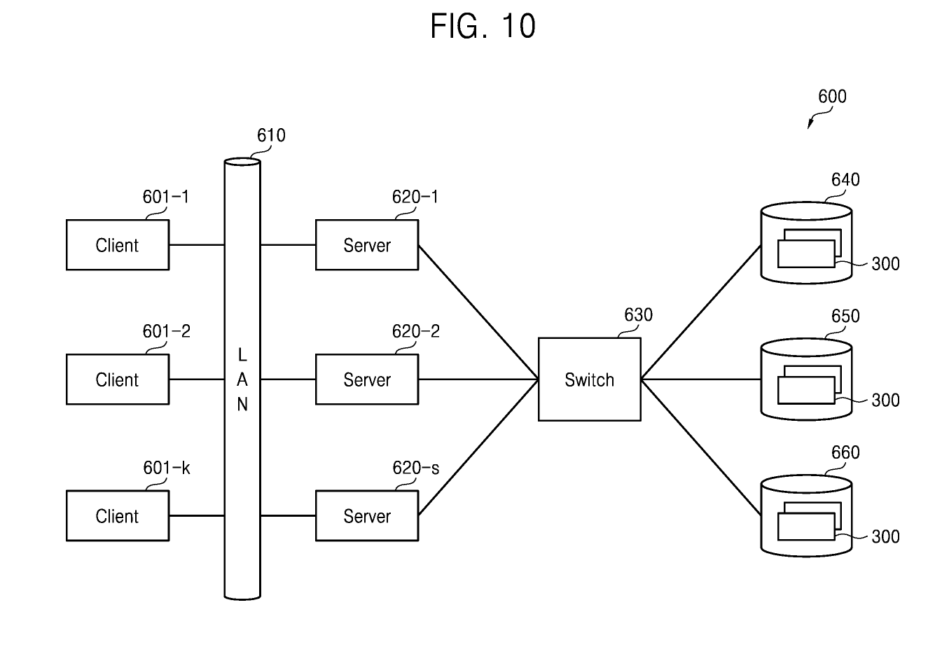

FIG. 10 is a block diagram of a data processing system 600 according to further embodiments of the inventive concept. Referring to FIGS. 1 through 7 and FIG. 10, the data processing system 600 may include a plurality of client computers 601-1 through 601-k, a local area network (LAN) 610, a plurality of servers 620-1 through 620-s (where “s” is a natural number of at least 3), a switch 630, and storages 630, 650, and 660. Each of the client computers 601-1 through 601-k may be implemented as a PC or a mobile device. The storages 630, 650, and 660 each may include at least one data storage device 300.

The data processing system 600 may be a SAN system and the at least one data storage device 300 may be a storage that can be used in a NAS. Each of the client computers 601-1 through 601-k may be connected to at least one of the servers 620-1 through 620-s via the LAN 610. Each of the servers 620-1 through 620-s may be connected to at least one of the storages 630, 650, and 660 through the switch 630.

As described above, according to an exemplary embodiment, a data storage device stores an instance in object-oriented programming language as it is in a memory device embedded therein, thereby reducing or dispersing a calculation load occurring during a process of writing data to the memory device and reading data from the memory device. In addition, the data storage device performs transformation from an instance in object-oriented programming language into object data and from object data into an instance therewithin. The data storage device directly stores an instance in object-oriented programming language in its embedded memory device.

While the inventive concept has been particularly shown and described with reference to exemplary embodiments thereof, it will be understood by those of ordinary skill in the art that various changes in forms and details may be made therein without departing from the spirit and scope of the inventive concept as defined by the following claims.

What is claimed is:

1. A method of operating a data storage device which is connected to a host and comprises a memory device and a controller, the method comprising:
receiving, by the controller, a first instance in object-oriented programming language in response to a write command from the host;
transforming, by the controller, the first instance into first object data; and
programming, by the controller, the first object data into the memory device.

2. The method of claim 1, further comprising:
reading, by the controller, the first object data from the memory device in response to a read command from the host;
transforming, by the controller, the first object data into the first instance; and
transmitting, by the controller, the first instance to the host.

3. The method of claim 2, wherein the data storage device is a solid state drive and the memory device is identified by one of channels and one of ways.

4. The method of claim 2, wherein the controller comprises a first central processing unit (CPU) in communication with the host and a second CPU in control of the memory device, and
wherein the second CPU comprises an application programming interface (API) to perform the transforming the first instance into the first object data and the transforming the first object data into the first instance.

5. The method of claim 4, wherein the first CPU and the second CPU share a semiconductor substrate with each other.

6. The method of claim 4, wherein the first CPU and the second CPU are formed in different chips respectively.

7. The method of claim 1, wherein the data storage device further comprises dynamic random access memory (DRAM) connected to the controller, and
wherein the controller and the DRAM are packaged in a single package.

8. The method of claim 1, wherein the data storage device further comprises dynamic random access memory (DRAM) connected to the controller, and
wherein the controller, the DRAM, and the memory device are packaged in a single package.

9. The method of claim 1, wherein the object-oriented programming language is Java programming language.

10. A method of operating a data processing system which comprises a host and a data storage device, the method comprising:
receiving, by a controller embedded in the data storage device, a first instance in object-oriented programming language in response to a write command from the host;
transforming, by the controller, the first instance into first object data; and
programming, by the controller, the first object data into a memory device embedded in the data storage device.

11. The method of claim 10, further comprising:
reading, by the controller, the first object data from the memory device in response to a read command from the host by the controller;
transforming, by the controller, the first object data into the first instance; and
transmitting, by the controller, the first instance to the host.

12. The method of claim 11, wherein the data storage device is one of a direct attached storage, a data storage for a storage area network, and a network attached storage.

13. The method of claim 11, wherein the controller comprises a first central processing unit (CPU) in communication with the host and a second CPU in control of the memory device, and the second CPU comprises an application programming interface (API) to perform the transforming the first instance into the first object data and the transforming the first object data into the first instance.

14. The method of claim 11, wherein the data processing system further comprises dynamic random access memory (DRAM) connected to the controller, and
wherein the controller, and the DRAM are packaged in a single package.

15. The method of claim 11, wherein the object-oriented programming language is Java programming language.

16. A method of operating a data processing system which comprises a host and a data storage device, the method comprising:
transmitting, by the host, an instance in object-oriented programming language, which is stored in a first memory device of the host, to the data storage device during a write operation; and
programming, by the data storage device, the instance as it is to a second memory device embedded in the data storage device during the write operation.

17. The method of claim 16, further comprising:
reading, by the data storage device, the instance from the second memory device in response to a read command output from the host during a read operation; and
transmitting, by the data storage device, the instance as it is to the host during the read operation.

18. The method of claim 16, further comprising, before the write operation:
transmitting, by the host, a read command to the data storage device;
transmitting, by the data storage device, object data that has been stored in the second memory device to the host in response to the read command; and
transforming, by the host, the object data into the instance and storing the instance in the first memory device.

19. The method of claim 16, wherein the data storage device is one of a direct attached storage, a data storage for a storage area network, and a network attached storage.

20. The method of claim 16, wherein the object-oriented programming language is Java programming language.
